(19) United States
(12) Patent Application Publication
(10) Pub. No.: US 2018/0114336 A1
(43) Pub. Date: Apr. 26, 2018

(54) POSITIONING METHOD AND IMAGE CAPTURING DEVICE THEREOF

(71) Applicant: INDUSTRIAL TECHNOLOGY RESEARCH INSTITUTE, Hsinchu (TW)

(72) Inventors: Po-Feng CHANG, Taitung County (TW); Wei-Cheng LIU, Zhubei City (TW); Pai-Wei CHENG, Taipei City (TW)

(73) Assignee: INDUSTRIAL TECHNOLOGY RESEARCH INSTITUTE, Hsinchu (TW)

(21) Appl. No.: 15/388,833

(22) Filed: Dec. 22, 2016

(30) Foreign Application Priority Data
Oct. 24, 2016 (TW) 105134348

(51) Int. Cl. G06T 7/73; G01S 19/13

(52) U.S. Cl. CPC G06T 7/73; G06T 2207/10032; G01S 19/13

(57) ABSTRACT

A positioning method includes the steps of: capturing a positioning image by an image capturing device, determining a pixel coordinate of an object in the positioning image, and determining a global positioning system coordinate of the object according to the pixel coordinates and a transformation matrix. An image capturing device includes a camera configured to capture a positioning image, a storage medium storing with a transformation matrix, and a processor electrically connected to the camera and the storage medium respectively. The processor is configured to determine a pixel coordinate of an object in the positioning image and determine a global positioning system coordinate associated with the object according to the pixel coordinate and the transformation matrix.

### CROSS-REFERENCE TO RELATED APPLICATIONS

This non-provisional application claims priority under 35 U.S.C. § 119(a) on Patent Application No(s). 105134348 filed in Taiwan, R.O.C. on Oct. 24, 2016, the entire contents of which are hereby incorporated by reference.

### TECHNICAL FIELD

The disclosure relates to a positioning method and an image capturing device thereof.

### BACKGROUND

Global positioning system (GPS) has been widely used for many kinds of transportation devices; one of the examples is that GPS is utilized in a navigation system. However, when it comes to complicated terrain or bad weather condition, it takes a huge amount of time for GPS to converge its error to be within an acceptable range. For instance, it may take one to a couple minutes for GPS to converge the error of a positioning coordinate to be suitable for a navigation system when the GPS is surrounded by skyscrapers in a downtown area. Thus, how to provide a positioning method for GPS to decrease the time spent on positioning becomes a pending problem that needs to be solved.

### SUMMARY

According to an embodiment of the present disclosure, a method for positioning is disclosed. The method comprises: capturing a positioning image by an image capturing device; determining a pixel coordinate of an object in the positioning image, and determining a global positioning system coordinate of the object according to the pixel coordinates and a transformation matrix.

According to another embodiment of the present disclosure, a method for obtaining positioning coordinate is provided. The method comprises: obtaining a first global positioning system coordinate and an error radius by a global positioning system; and requesting a cloud server for a second global positioning system coordinate that is obtained by the method as described in the above-mentioned embodiment.

According to one another embodiment of the present disclosure, an image capturing device is provided. The image capturing device comprises: a camera, configured to capture a positioning image; a storage medium storing with a transformation matrix; and a processor electrically connected to the camera and the storage medium respectively, configured to determine a first pixel coordinates of an object in the positioning image and determine a global positioning system coordinate associated with the object according to the first pixel coordinates and the transformation matrix.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view illustrating the allocation of a positioning system according to one of the embodiments of the present disclosure;

FIG. 2 is a flowchart of a positioning method according to one of the embodiments of the present disclosure;

FIG. 3 is a flowchart of a positioning method according to another embodiment of the present disclosure;

FIG. 4 is a flowchart of a positioning method according to one another embodiment of the present disclosure; and

FIG. 5 is a schematic view illustrating the function blocks of an image capturing device.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

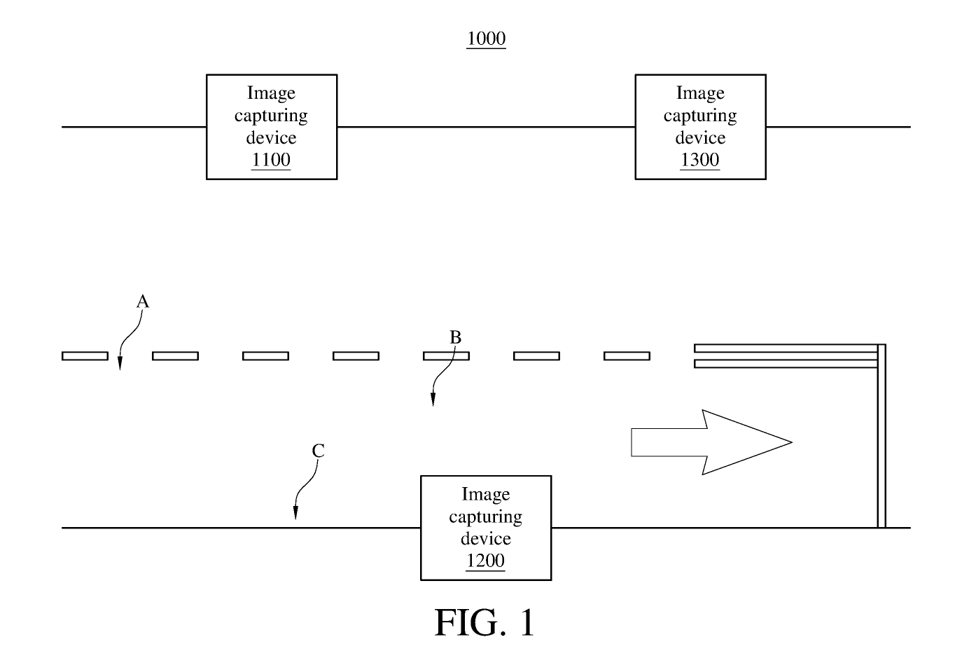

FIG. 1 is a schematic view illustrating the allocation of a positioning system according to one of the embodiments of the present disclosure. According to a positioning system 1000 as disclosed in FIG. 1 in the present disclosure, one among the image capturing devices 1100 to 1300 (e.g. image capturing device 1100) is firstly configured to capture an image from a target area. The global positioning system coordinates (geographic coordinates) of the three positions A, B and C in the captured image have already been built in the image capturing device 1100. With the global positioning system coordinates of these three positions and the pixel coordinates of these three positions in the image, a coordinate transformation matrix between a pixel coordinate of an image captured by the image capturing device 1100 and a global positioning system coordinate may be obtained. In one of the embodiments of the present disclosure, the global positioning system coordinate of the position A is (x1, y1), and its pixel coordinate in the image captured by the image capturing device 1100 is (r1, c1); the global positioning coordinate of position B is (x2, y2), and its pixel coordinate in the image captured by the image capturing device 1100 is (r2, c2); and the global positioning system coordinate of position C is (x3, y3), and its pixel coordinate in the image captured by the image capturing device 1100 is (r3, c3). In this case, by utilizing the six information listed above, a coordinate transformation matrix that maps a triangular area defined by the three pixel coordinates of the positions A, B and C in the image to a corresponding triangular area in the global positioning system coordinate may be obtained. Accordingly, assume that the terrain in the image captured by the image capturing device 1100 is flat, the image capturing device 1100 is able to estimate the global positioning system coordinate of an arbitrary point in the image through extrapolation or interpolation.

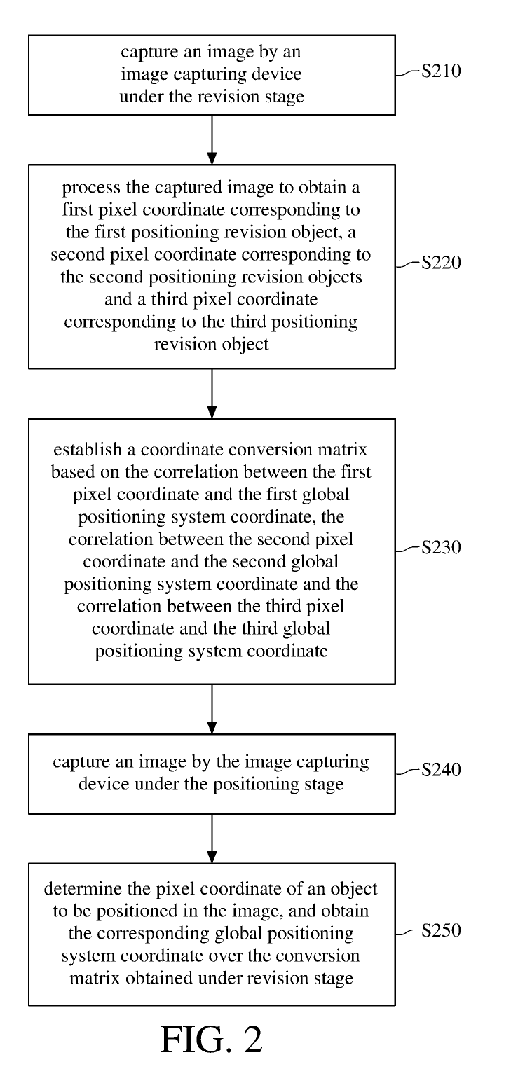

FIG. 2 depicts one of the embodiments of the present disclosure. FIG. 2 is a flowchart of a positioning method according to one of the embodiments of the present disclosure. As shown in FIG. 2, the positioning method may be performed by the following steps. In step S210, capture an image by an image capturing device under the revision stage. The captured image includes images of at least three positioning revision objects. Take the three positioning revision objects as an example hereafter, the three positioning revision objects C1-C3 should be recognizable, the first positioning revision object C1 correspondingly has a first global positioning system coordinate G1, the second positioning revision object C2 correspondingly has a second global positioning system coordinate G2, and the third positioning revision object C3 correspondingly has a third global positioning system coordinate G3. Particularly, the first positioning revision object C1 is located at the position A, which means the value of the first global positioning coordinate G1 is (x 1, y1). Next, in step S220, process the captured image to obtain a first pixel coordinate corresponding to the first positioning revision object C1, a second pixel coordinate corresponding to the second positioning revision objects C2 and a third pixel coordinate corresponding to the third positioning revision object C3. Since the positioning revision objects C1-C3 are recognizable, which implies a processor of the image capturing device 1100 can distinguish them from each other, the three positioning revision objects of the image may be recognized. The corresponding pixel coordinates of the positioning revision objects may also be obtained by calculation.

Subsequently, in step S230, the processor, based on the correlation between the first pixel coordinate P1 and the first global positioning system coordinate G1, the correlation between the second pixel coordinate P2 and the second global positioning system coordinate G2 and the correlation between the third pixel coordinate P3 and the third global positioning system coordinate G3, may establish a coordinate transformation matrix, which is a perspective transformation matrix.

In step S240, under the positioning stage, capture an image by the image capturing device. In step S250, the processor of the image capturing device 1100 determines the pixel coordinate of an object to be positioned in the image, and obtains a global positioning system coordinate corresponding to the pixel coordinate of the object to be positioned through the transformation matrix obtained under the revision stage. The global positioning system coordinate of the object to be positioned is then acquired.

In one embodiment, when computing the pixel coordinate of the object to be positioned in the image is desired, the tire of the object to be positioned is selected as a basis for determination. In this embodiment, correspondingly, under the revision stage, the bottom (the contact point with the ground) of the positioning revision object is used as a basis for determination of the pixel coordinate of the object to be positioned. In another embodiment, the rooftop of a vehicle is selected as a basis for determination when computing the pixel coordinate of the object to be positioned (vehicle) in the image is desired. In such embodiment, under the revision stage, the top of the positioning revision object is selected as a basis for determining the pixel coordinate, and the height of the positioning revision object may be between 1 to 2.5 meters. Precisely speaking, if the objects to be positioned in a field are mostly bulky vehicles, then 2.5 meters should be selected as the height of the objects. In the contrary, if the objects to be positioned in a field are mostly sedans, then 1.3 to 1.6 meters would be a range from which the height of the objects should be selected.

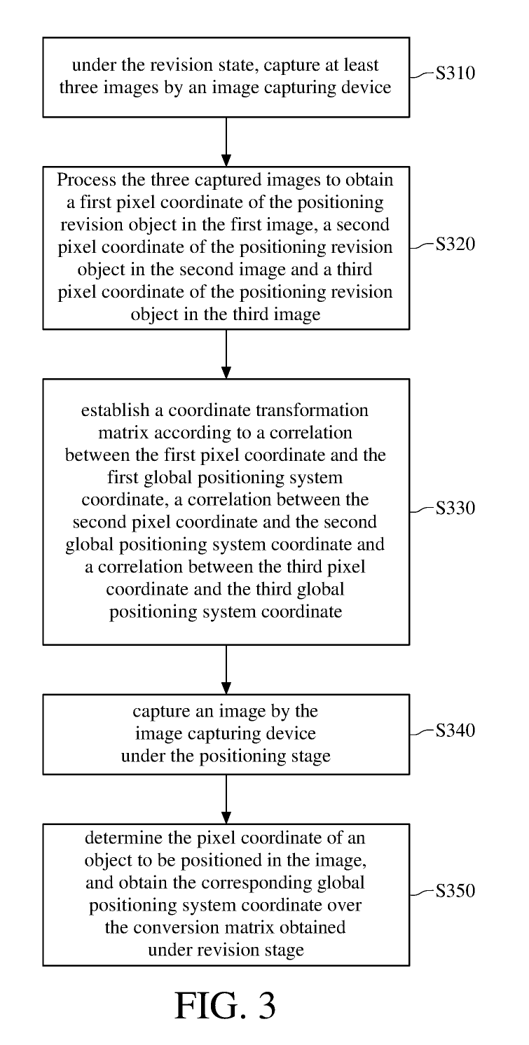

In another embodiment, please refer to FIG. 3, which is a flowchart of a positioning method according to another embodiment of the present disclosure. As shown in FIG. 3, the positioning method may be performed by the following steps. In step S310, under the revision state, capture at least three images by an image capturing device, wherein every captured image has an image of the positioning revision object C4. Take three images as an example, the positioning revision object C4 in the first image has a first global positioning system coordinate G1, the positioning revision object C4 in the second image has a second global positioning system coordinate G2 and the positioning revision object C4 in the third image has a third global positioning system coordinate G3. In step S320, the processor processes the three captured images to obtain a first pixel coordinate P1 of the positioning revision object C4 in the first image, a second pixel coordinate P2 of the positioning revision object C4 in the second image and a third pixel coordinate P3 of the positioning revision object C4 in the third image. In step S330, the processor of the image capturing device 1100 establish a coordinate transformation matrix according to a correlation between the first pixel coordinate P1 and the first global positioning system coordinate G1, a correlation between the second pixel coordinate P2 and the second global positioning system coordinate G2 and a correlation between the third pixel coordinate P3 and the third global positioning system coordinate G3. Under the positioning stage, as the steps S240-S250 of FIG. 2, the global positioning system coordinate of the object to be positioned may be obtained.

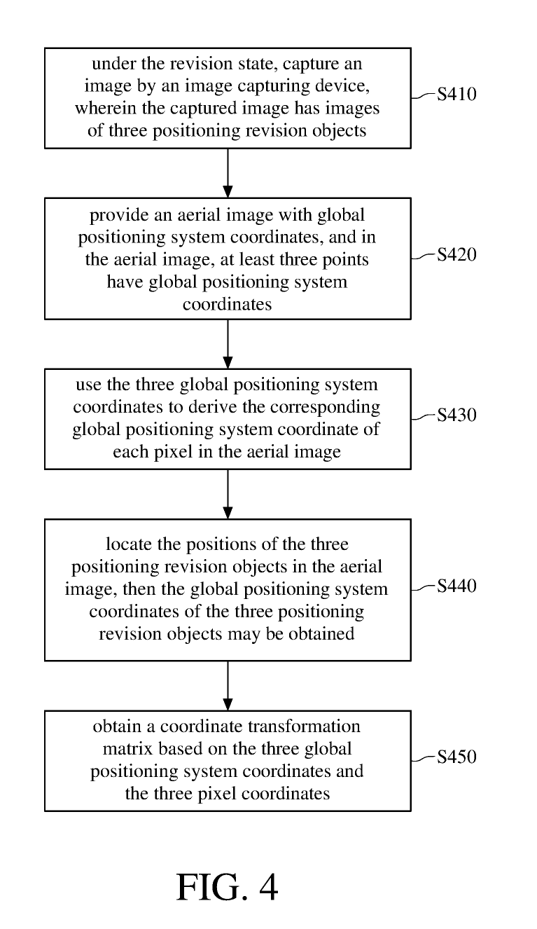

In one another embodiment, please refer to FIG. 4, which is a flowchart of a positioning method according to one another embodiment of the present disclosure. As shown in FIG. 4, the positioning method may by performed by the following steps. In step S410, under the revision state, capture an image by an image capturing device, wherein the captured image has images of three positioning revision objects C5-C7, and the three positioning revision objects C5-C7 are recognizable. The first positioning revision object C5 to the third positioning revision object C7 may be fixed referencing objects (e.g. traffic lights, corners of a building). The three positioning revision objects C5-C7 in the image correspond to three pixel coordinates P5-P7 respectively. In step S420, provide an aerial image with global positioning system coordinates, and in the aerial image, at least three points have global positioning system coordinates GC1-GC3. In step S430, the processor may use the three global positioning system coordinates to derive the corresponding global positioning system coordinate of each pixel in the aerial image. In step S440, the processor locates (or processed and marked out by a person) the positions of the three positioning revision objects in the aerial image, then the global positioning system coordinates G5-G7 of the three positioning revision objects C5-C7 may be obtained. In step S450, the processor obtains a coordinate transformation matrix based on the three global positioning system coordinates G5-G7 and the three pixel coordinates P5-P7. Under the positioning stage, as the steps S240-S250 shown in FIG. 2, the global positioning system coordinate of the object to be positioned may be obtained.

In this embodiment, the revision and positioning may be performed simultaneously. Thus, the image capturing device may be prevented from being moved by earthquake or other factors (man-made movement), and positioning errors from the movement are able to be further prevented. Preciously speaking, a new transformation matrix is re-generated each time an image is captured, for the use of positioning.

In one embodiment, if the positioning system equipped on a vehicle is capable of accessing internet, the vehicle is able to obtain a first global positioning system coordinate with the global positioning system equipped thereon, and request for a second global positioning system coordinate from a cloud server. Coordinates stored in the cloud server are obtained by the method of the present disclosure by using image recognition. Since the global positioning system equipped on the vehicle would give out an error (error radius), the coordinate shown on the interface of the vehicle would be the second global positioning system coordinate when the error is greater than a threshold.

In another embodiment, the vehicle firstly requests for a first global positioning system coordinate from a global positioning system, and when the global positioning system returns the first global positioning system coordinate, the vehicle obtains a corresponding error simultaneously. A telematics (or a general vehicle-used computer) of the vehicle is adopted to determine whether the error is greater than a threshold. For example, the threshold may be predetermined at 0.3 meter. When the error is not greater then the threshold (or smaller than the threshold), the telematics may display the first global positioning system coordinate directly. In one embodiment, when the error is greater than the threshold, the vehicle-used computer obtains an internet connection with a nearest image capturing device via a technology of internet of things (IoT). Moreover, the telematics requests for a second global positioning system coordinate from the image capturing device.

In another embodiment, the vehicle may not need a global positioning system. Instead, the vehicle requests for a global positioning system coordinate from a cloud server over an internet or a nearest image capturing device directly over a technology of IoT. In one another embodiment, the vehicle is equipped with a global positioning system, but however a positioning coordinate is obtained from the global positioning system only when the cloud server or the nearest image capturing device is unavailable, or coordinates of the cloud server have not been updated for more than a predetermined value (e.g. 1 minute).

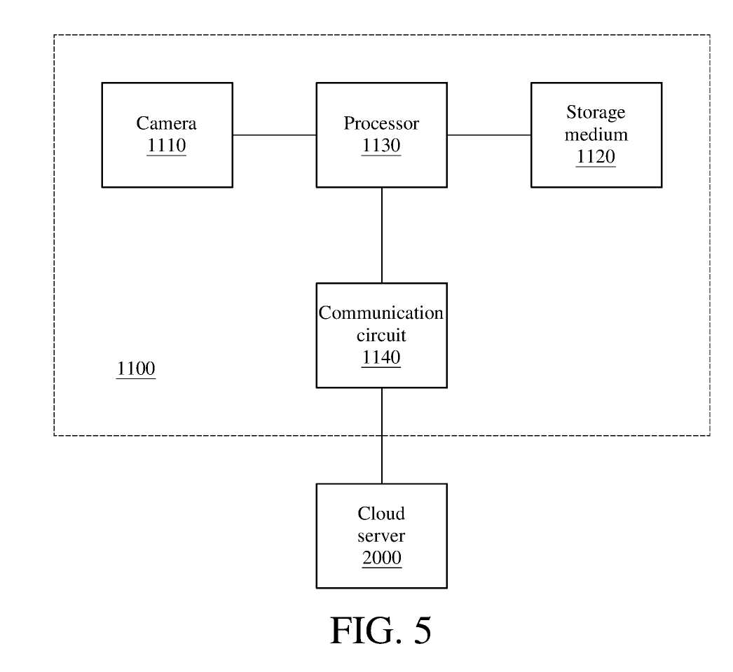

In one embodiment, please refer to FIG. 5, which is a schematic view illustrating the function blocks of an image capturing device. As shown in FIG. 5, the image capturing device 1100 of FIG. 1 has a camera 1110, a storage medium 1120, and a processor 1130. The camera 1110 is configured to capture positioning images. That is to say, when an object to be positioned (a vehicle) enters into the field set by the camera 1110, the camera 1110 is capable of capturing the image including the object. The storage medium 1120 stores the transformation matrix as established by steps S210-S230 in the previous FIG. The processor 1130 electrically connects with the camera 1110 and the storage medium 1120 respectively, and is configured to determine a first pixel coordinate of an object to be positioned in the image, and to generate a global positioning system coordinate associated with the object to be positioned based on the first pixel coordinate and the transformation matrix. However how to perform should be understood by person with ordinary skill in the art, and detailed description is thus omitted. The storage medium 1120 of the present embodiment may be volatile or non-volatile storage medium and should not limit the scope of the present disclosure.

In one embodiment, the image capturing device 1110 may further comprise a communication circuit 1140. In one embodiment, global positioning system coordinates of the object to be positioned obtained by the processor 1130 may be transmitted to the cloud server 2000 through the communication circuit 1140. Therefore, the object to be positioned (vehicle) may request for its own global positioning system coordinate from the cloud server any time. In another embodiment, the global positioning system coordinates of the object to be positioned obtained by the processor 1130 may be stored in the storage medium. When the object to be positioned connects to the communication circuit 1140 via a technology of IoT, the processor may based on the request of the object, return the global positioning system coordinate of the object to the object.

Hence, when the object to be positioned enters into the field set by the image capturing device, the object to be positioned does not need to turn the global positioning system, but only needs to connect with the image capturing device via internet or other measurements, to obtain its own global positioning system coordinate.

What is claimed is:

1. A positioning method, comprising:
capturing a positioning image by an image capturing device;
determining a pixel coordinate of an object in the positioning image, and
determining a global positioning system coordinate of the object according to the pixel coordinate and a transformation matrix.

2. The positioning method as claimed in claim 1, further comprising:
capturing, by the image capturing device, a revision image with at least three revision pixel coordinates, the at least three revision pixel coordinates respectively corresponding to images of at least three positioning revision objects in the revision image;
obtaining the global positioning system coordinates corresponding to the positioning revision objects; and
obtaining the transformation matrix according to the global positioning system coordinates corresponding to the positioning revision objects and the revision pixel coordinates.

3. The positioning method as claimed in claim 2, wherein the obtaining the global positioning system coordinates corresponding to the positioning revision objects comprises:
allocating a global positioning system to each of the positioning revision objects to obtain the corresponding global positioning system coordinates.

4. The positioning method as claimed in claim 2, wherein the obtaining the global positioning system coordinates corresponding to the positioning revision objects comprises:
providing an aerial image with at least three global positioning system coordinates; and
determining the global positioning system coordinates corresponding to the positioning revision objects according to the aerial image.

5. The positioning method as claimed in claim 1, further comprising:
capturing a first revision image by the image capturing device, the first revision image comprising an image of a positioning revision object, the positioning revision object comprising a first global positioning system coordinate, and the image of the positioning revision object comprising a first pixel coordinate in the first revision image;
moving the positioning revision object to a second global positioning system coordinate;
capturing a second revision image by the image capturing device, an image of the positioning revision object comprising a second pixel coordinate in the second revision image;
moving the positioning revision object to a third global positioning system coordinate;
capturing a third revision image by the image capturing device, an image of the positioning revision object comprising a third pixel coordinate in the third revision image; and
obtaining the transformation matrix according to the pixel coordinates and the first, second, and third global positioning system coordinates.

6. The positioning method as claimed in claim 1, further comprising:
obtaining at least three revision pixel coordinates from the positioning image, wherein the revision pixel coordinates correspond respectively to images of at least three positioning revision objects in the positioning image;
obtaining at least three global positioning system coordinates corresponding to the positioning revision objects; and
obtaining the transformation matrix according to the at least three global positioning system coordinates corresponding to the positioning revision objects and the revision pixel coordinates.

7. The positioning method as claimed in claim 6, further comprising:
providing an aerial image with at least three global positioning system coordinates; and
determining the global positioning system coordinates corresponding to the positioning revision objects according to the aerial image.

8. A method for obtaining positioning coordinate, comprising:
obtaining a first global positioning system coordinate and an error radius by a global positioning system; and
requesting a cloud server for a second global positioning system coordinate that is obtained by the method as claimed in claim 1 when the error radius is greater than a threshold.

9. An image capturing device, comprising:
a camera, configured to capture a positioning image;
a storage medium storing a transformation matrix; and
a processor electrically connected to the camera and the storage medium respectively, configured to determine a first pixel coordinate of an object in the positioning image and determine a global positioning system coordinate associated with the object according to the first pixel coordinate and the transformation matrix.

10. The image capturing device as claimed in claim 9, wherein the image capturing device further comprises a communication circuit electrically connected to the processor and a cloud server, and the cloud server is configured to transmit the global positioning system coordinate to the cloud server.

11. The image capturing device as claimed in claim 9, wherein the storage medium further stores an aerial image with at least three global positioning system coordinates, the processor obtains the transformation matrix according to the at least three global positioning system coordinates and the positioning image.
